(19) United States
(12) Patent Application Publication
(10) Pub. No.: US 2026/0249742 A1
(43) Pub. Date: Aug. 27, 2026

(54) EQUIPMENT MODULE

(71) Applicant: DENSO CORPORATION, Kariya-city (JP)

(72) Inventor: Koichi UMEDA, Kariya-city (JP)

(73) Assignee: DENSO CORPORATION, Kariya-city (JP)

(21) Appl. No.: 19/651,912

(22) Filed: Apr. 20, 2026

Related U.S. Application Data
(63) Continuation of application No. PCT/JP2024/039804, filed on Nov. 8, 2024.

(30) Foreign Application Priority Data
Nov. 17, 2023 (JP) 2023-196231

(51) Int. Cl. B60L 58/19; H01M 50/509; H02J 7/50

(52) U.S. Cl. CPC B60L 58/19; H01M 50/509; H02J 7/575; H01M 2220/20

(57) ABSTRACT

An equipment module switches between series and parallel connections of a first battery and a second battery. The equipment module includes a series relay and a parallel relay. The series relay selectively forms a series electrical path between the first battery and the second battery using a series fixed terminal and a series movable terminal. A series rod extends through the series movable terminal and guides movement between contact and separation. The parallel relay selectively forms a parallel electrical path between the first battery and the second battery using a parallel fixed terminal and a parallel movable terminal. The parallel fixed terminal is electrically connected to a current path different from a current path connected to the series fixed terminal. A parallel rod extends through the parallel movable terminal and guides movement of the parallel movable terminal. The series rod and the parallel rod extend in different directions.

### CROSS REFERENCE TO RELATED APPLICATIONS

The present application is a continuation application of International Patent Application No. PCT/JP2024/039804 filed on November 8, 2024, which designated the U.S. and claims the benefit of priority from Japanese Patent Application No. 2023-196231, filed on November 17, 2023. The entire disclosures of all of the above applications are incorporated herein by reference.

### TECHNICAL FIELD

The present disclosure relates to an equipment module.

### BACKGROUND

A vehicle equipped includes a power storage device. The power storage device includes two battery modules and three relays.

### SUMMARY

According to at least one embodiment, an equipment module is for switching between a series connection and a parallel connection of a first battery and a second battery including a series relay and a parallel relay. The series relay connects the first battery and the second battery in series. The parallel relay connects the first battery and the second battery in parallel. The series relay includes a series fixed terminal electrically connected to a current path. The series relay includes a series movable terminal that comes into contact with and separates from the series fixed terminal. The series relay includes a series rod extending through the series movable terminal to guide movement of the series movable terminal. The parallel relay includes a parallel fixed terminal electrically connected to a current path different from the current path to which the series fixed terminal is connected. The parallel relay includes a parallel movable terminal that comes into contact with and separates from the parallel fixed terminal. The parallel relay includes a parallel rod extending through the parallel movable terminal to guide movement of the parallel movable terminal. An extending direction of the series rod and an extending direction of the parallel rod may be different from each other.

### BRIEF DESCRIPTION OF DRAWINGS

The details of one or more embodiments are set forth in the accompanying drawings and the description below. Other features and advantages will be apparent from the description and drawings, and from the claims.

To begin with, examples of relevant techniques will be described.

FIG. 1 is a schematic diagram for explaining a power supply system.

FIG. 2 is a circuit diagram for explaining a current path during traveling.

FIG. 3 is a circuit diagram for explaining a current path during charging.

FIG. 4 is a circuit diagram for explaining a current path during charging.

FIG. 5 is a top view of an equipment module.

FIG. 6 is a schematic diagram of a relay.

FIG. 7 is a schematic diagram illustrating a series relay and a parallel relay extracted from the equipment module.

FIG. 8 is a schematic diagram illustrating a series relay and a parallel relay extracted from an equipment module according to a second embodiment.

FIG. 9 is a schematic diagram illustrating a series relay and a parallel relay extracted from an equipment module according to a third embodiment.

FIG. 10 is a schematic diagram illustrating a series relay and a parallel relay extracted from an equipment module according to a fourth embodiment.

### DETAILED DESCRIPTION

A vehicle equipped according to a comparative example includes a power storage device. The power storage device includes two battery modules and three relays. One of the relays is provided on a wire that connects positive electrodes of the two battery modules. Another relay is provided on a wire that connects a positive electrode of one battery module to a negative electrode of the other battery module. Yet another relay is provided on a wire that connects the negative electrodes of the two battery modules. The three relays are arranged in a circuit including the two battery modules so as to be capable of switching between a series state and a parallel state.

In a case where electromagnetic mechanical relays are used as switches, there is a risk that all three relays may unintentionally turn on simultaneously in an event of large vibrations or the like.

In contrast to the comparative example, according to an equipment module of the present disclosure, unintentional simultaneous activation of both a series relay and a parallel relay can be reduced.

According to one aspect of the present disclosure, an equipment module is for switching between a series connection and a parallel connection of a first battery and a second battery including a series relay and a parallel relay. The series relay connects the first battery and the second battery in series. The parallel relay connects the first battery and the second battery in parallel. The series relay includes a series fixed terminal electrically connected to a current path. The series relay includes a series movable terminal that comes into contact with and separates from the series fixed terminal. The series relay includes a series rod extending through the series movable terminal to guide movement of the series movable terminal. The parallel relay includes a parallel fixed terminal electrically connected to a current path different from the current path to which the series fixed terminal is connected. The parallel relay includes a parallel movable terminal that comes into contact with and separates from the parallel fixed terminal. The parallel relay includes a parallel rod extending through the parallel movable terminal to guide movement of the parallel movable terminal. An extending direction of the series rod and an extending direction of the parallel rod are different from each other.

According to this configuration, unintentional simultaneous activation of both the series relay and the parallel relay can be reduced due to large vibrations or the like.

Hereinafter, embodiments for carrying out the present disclosure are described with reference to the drawings. In each embodiment, parts corresponding to the elements described in the preceding embodiments are denoted by the same reference numerals, and redundant explanation may be omitted. When only a part of a configuration is described in an embodiment, another preceding embodiment may be applied to the other parts of the configuration.

It may be possible not only to combine parts the combination of which is explicitly described in an embodiment, but also to combine parts of respective embodiments the combination of which is not explicitly described if any obstacle does not especially occur in combining the parts of the respective embodiments.

### First Embodiment

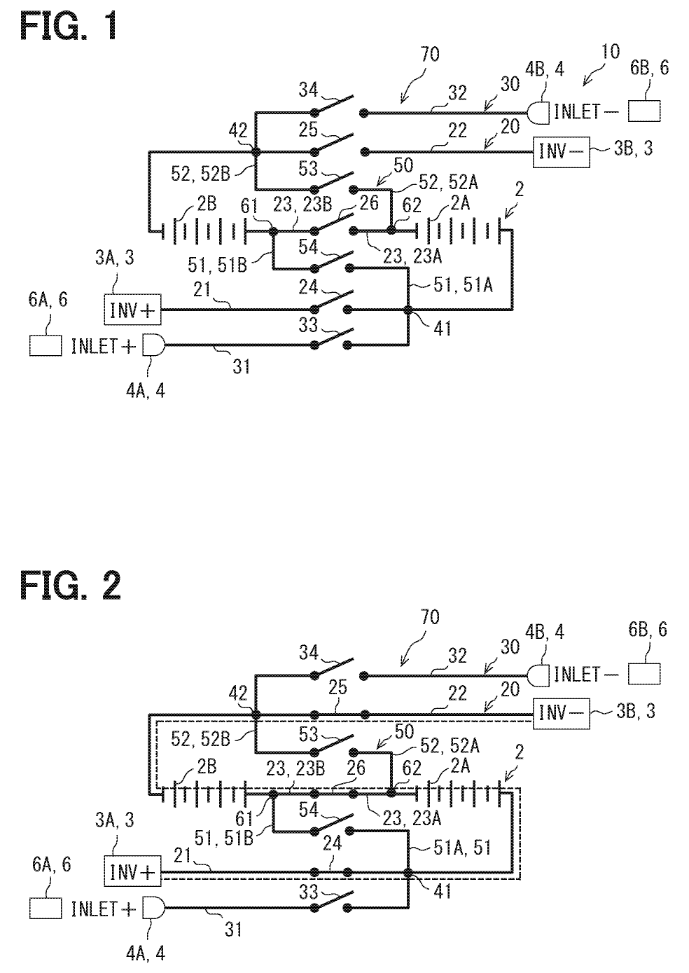

A high-voltage junction box 10 according to a first embodiment shown in FIG. 1 is used in electric vehicles such as BEVs (Battery Electric Vehicles). The high-voltage junction box 10 is mounted on an electric vehicle together with a battery device 2, a power conversion device 3, and a charging inlet 4, among others. The high-voltage junction box 10 is electrically connected to the battery device 2, the power conversion device 3, the charging inlet 4, and the like. The high-voltage junction box 10 may also be referred to as an equipment module. The battery device 2 may also be referred to as a power supply device.

The battery device 2 includes a first battery 2A and a second battery 2B. The first battery 2A and the second battery 2B each include battery cells. A battery cell is one of the battery cells. The battery cell is, for example, a secondary battery such as a lithium battery. The first battery 2A and the second battery 2B are configured by electrically connecting the battery cells in series. It should be noted that the first battery 2A may also be referred to as a first cell. The second battery 2B may also be referred to as a second cell.

In the present embodiment, the number of battery cells included in the first battery 2A and the second battery 2B is equal. The first battery 2A and the second battery 2B output a supply voltage of approximately 400 [V]. The supply voltage may also be referred to as output electric power. A supply voltage of approximately 400 [V] is individually output from either the first battery 2A or the second battery 2B. Alternatively, a supply voltage of approximately 800 [V], integrated from the first battery 2A and the second battery 2B, is output. When the first battery 2A and the second battery 2B are connected in series, a rated voltage of the battery device 2 is 800 [V]. When the first battery 2A and the second battery 2B are connected in parallel, the rated voltage of the battery device 2 is 400 [V]. It should be noted that the voltages of the first battery 2A and the second battery 2B do not have to be the same.

A switching of the output of such supply power is performed by the high-voltage junction box 10. The high-voltage junction box 10 may also be referred to as a power distribution device. By switching the output of the supply power with the high-voltage junction box 10, supply power of approximately 400 [V] or approximately 800 [V] is provided to the power conversion device 3.

The power conversion device 3 mainly includes an inverter. The inverter is connected to a motor-generator of the electric vehicle. The inverter converts a supplied DC source power into an AC power. The AC power is supplied to the motor generator. The motor generator works in powering by this AC power. The powering drives running wheels of the electric vehicle to rotate. The motor-generator also converts kinetic energy of the drive wheels into electrical energy. The motor generator works regenerating. The AC power generated by regenerative power generation is converted into DC power by the power conversion device 3. This DC power is supplied to the battery device 2 via the high-voltage junction box 10.

A charging cable of a charging stand 6, which is provided outside the vehicle, is connected to the charging inlet 4. DC power for charging the battery device 2 is applied to the charging inlet 4. The charging inlet 4 supplies the DC power input from the charging stand 6 to the high-voltage junction box 10. The charging stand 6 is installed at charging facilities and similar locations. Charging of the battery device 2 from the charging stand 6 is carried out via the charging inlet 4. The charging stand 6 may also be referred to as an external charger. The charging stand 6 includes both a normal charger and a rapid charger.

An example of a normal charger includes a single-phase AC power supply with a voltage of 200 [V] or 100 [V], and is configured to supply AC power with an output of approximately 3 [kW] (200 [V], maximum current 15 [A]). An example of a rapid charger is configured to supply DC power with a maximum output of 160 [kW] (maximum voltage 400 [V], maximum current 400 [A]). This rapid charger may be referred to as a low-voltage rapid charger. Another example of a rapid charger is configured to supply DC power with a maximum output of 160 [kW] (maximum voltage 800 [V], maximum current 200 [A]). This rapid charger may be referred to as a high-voltage rapid charger.

Rapid charging is a charging method intended to charge the battery device 2 in a short period of time by supplying a large current to the battery device 2. The rapid charging is performed using direct current (DC). The charging in this embodiment may also be referred to as DC (Direct Current) charging. Here, a large current refers to a current greater than that used in normal charging. A short period refers to a time shorter than that required for normal charging. In this embodiment, an example is adopted in which charging from the charging stand 6 to the battery device 2 is performed using a rapid charger.

The high-voltage junction box 10 is equipped with a power control circuit 70 and a mounting base 80 for securing the power control circuit 70. The power control circuit 70 includes electric current paths. The power control circuit 70 performs switching between the electric current paths. The power control circuit 70 includes a first wire 20, a second wire 30, and a third wire 50. The first wire 20, the second wire 30, and the third wire 50 are formed, for example, from plate members made of copper such as busbars.

The first wire 20 is a power line that connects the first battery 2A and the second battery 2B in series, and is also connected to the power conversion device 3. The first wire 20 includes a first connecting piece 21, a second connecting piece 22, and a third connecting piece 23. The first connecting piece 21 connects the power conversion device 3 to the first battery 2A. The second connecting piece 22 connects the power conversion device 3 to the second battery 2B. The third connecting piece 23 connects the first battery 2A to the second battery 2B. The first connecting piece 21 connects a positive electrode 3A of the power conversion device 3 to a positive electrode of the first battery 2A. The second connecting piece 22 connects a negative electrode 3B of the power conversion device 3 to a negative electrode of the second battery 2B. The third connecting piece 23 connects the negative electrode of the first battery 2A to the positive electrode of the second battery 2B.

The second wire 30 is a power line that is connected to the first wire 20 and the charging inlet 4. The second wire 30 includes a second positive wire 31 and a second negative wire 32. The second positive wire 31 connects the first connecting piece 21 to a positive electrode side of the charging inlet 4. The second negative wire 32 connects the second connecting piece 22 to a negative electrode side of the charging inlet 4. The charging inlet 4 includes a charging positive inlet 4A, which is connected to a positive electrode 6A of the charging stand 6, and a charging negative inlet 4B, which is connected to a negative electrode 6B of the charging stand 6. The first connecting piece 21 and the second positive wire 31 are electrically connected at a first connecting portion 41. The third connecting piece 23 and the second negative wire 32 are electrically connected at a second connecting portion 42.

The third wire 50 is a power line that connects the second connecting piece 22 to the connecting portions 41 and 42. The third wire 50 includes a third positive wire 51 and a third negative wire 52. The third positive wire 51 connects the third connecting piece 23 to the first connecting portion 41. The third negative wire 52 connects the third connecting piece 23 to the second connecting portion 42.

In addition to the wires 20, 30, and 50, the power control circuit 70 also includes seven relays 24, 25, 26, 33, 34, 53, and 54. The seven relays 24, 25, 26, 33, 34, 53, and 54 are system main relays 24 and 25, changeover relays 26, 53, and 54, and charging relays 33 and 34. The system main relays 24 and 25 include a system positive main relay 24 and a system negative main relay 25. The switching relays 26, 53, and 54 include a series relay 26 and parallel relays 53 and 54. The parallel relays 53 and 54 include a positive parallel relay 54 and a negative parallel relay 53. The charging relays 33 and 34 include a charging positive relay 33 and a charging negative relay 34. It should be noted that the positive parallel relay 54 may be referred to as a first parallel relay. The negative parallel relay 53 may be referred to as a second parallel relay.

The system positive main relay 24 is provided on the first connecting piece 21. The system positive main relay 24 is provided on the first connecting piece 21, between a connecting portion of the power conversion device 3 and the first connecting portion 41. The system negative main relay 25 is provided on the second connecting piece 22. The system negative main relay 25 is provided on the second connecting piece 22, between the connecting portion of the power conversion device 3 and the second connecting portion 42. The series relay 26 is provided on the third connecting piece 23.

The charging positive relay 33 is provided on the second positive wire 31. The charging negative relay 34 is provided on the second negative wire 32. The positive parallel relay 54 is provided on the third positive wire 51. One end of the third positive wire 51 is connected to the first connecting portion 41. The other end of the third positive wire 51 is connected between a connecting portion with the series relay 26 and a connecting portion with the second battery 2B in the third connecting piece 23. The connecting portion between the other end of the third positive wire 51 and the third connecting piece 23 may be referred to as a third connecting portion 61. A closed loop is formed by the third positive wire 51, the third connecting piece 23, the series relay 26, the first battery 2A, and a part of the first connecting piece 21.

The negative parallel relay 53 is provided on the third negative wire 52. One end of the third negative wire 52 is connected to the second connecting portion 42. The other end of the third negative wire 52 is connected to the third connecting piece 23 between the connecting portion with the series relay 26 and a connecting portion with the first battery 2A. The connecting portion between the other end of the third negative wire 52 and the third connecting piece 23 may be referred to as a fourth connecting portion 62. A closed loop is formed by the third negative wire 52, the third connecting piece 23, the series relay 26, the second battery 2B, and a portion of the second connecting piece 22.

As will be explained in detail later, the system main relays 24 and 25, as well as the series relay 26, are relays used during traveling at 800 [V]. The charging relays 33 and 34, as well as the series relay 26, are relays used during charging at 800 [V]. The parallel relays 53 and 54, as well as the charging relays 33 and 34, are relays used during charging at 400 [V].

The system main relays 24 and 25, the changeover relays 26, 53, and 54, and the charging relays 33 and 34 open and close in response to control signals from an ECU. The ECU is equipped with a processing unit such as a central processing device (i.e., CPU), a memory device including a random access memory (i.e., RAM) and a read only memory (i.e., ROM), and input/output devices. In addition to the seven relays 24, 25, 26, 33, 34, 53, and 54, the input/output device can be electrically connected to each switching element of the power conversion device 3 and to the charging station 6.

The processing unit executes programs stored in the memory device. The processing unit performs computational processing in accordance with the program. The processing unit also performs computational processing using data stored in the memory device. Then, the processing unit controls each switching element and the seven relays 24, 25, 26, 33, 34, 53, and 54 via the input/output device. In the present embodiment, the processing operations performed by the processing unit are described as the processing operations of the ECU. The ECU can also be referred to as an electronic control unit.

### 800 [V] Operation

The processing unit is configured to be electrically connectable to the charging station 6 via the input/output device. When charging from the charging station 6 to the battery device 2 is not performed, the processing unit outputs ON signals to the system main relays 24, 25 and series relay 26. At the same time, the processing unit outputs OFF signals to the charging relays 33, 34 and the parallel relays 53, 54. Accordingly, a current path through which an electric current flows, as indicated by a dashed line in FIG. 2, is formed. The current path is a route that includes the energized relays 24, 25, 26, the first battery 2A, the second battery 2B, and the first wire 20.

Due to the above-described electrical connection configuration, when charging from the charging station 6 to the battery device 2 is not performed, the first battery 2A and the second battery 2B are electrically connected in series. A potential difference between the first connecting piece 21 and the second connecting piece 22 is approximately 800 [V]. The battery device 2 is connected to the power conversion device 3 via the first connecting piece 21 and the second connecting piece 22. The electric power of approximately 800 [V] is being supplied to the power conversion device 3.

The power conversion device 3 converts the supplied electric power from direct current to alternating current. The 800 [V] power, converted to alternating current, is supplied to the motor generator. The motor generator operates based on the converted alternating current power. As a result, the electric vehicle runs.

### 800 [V] Charging

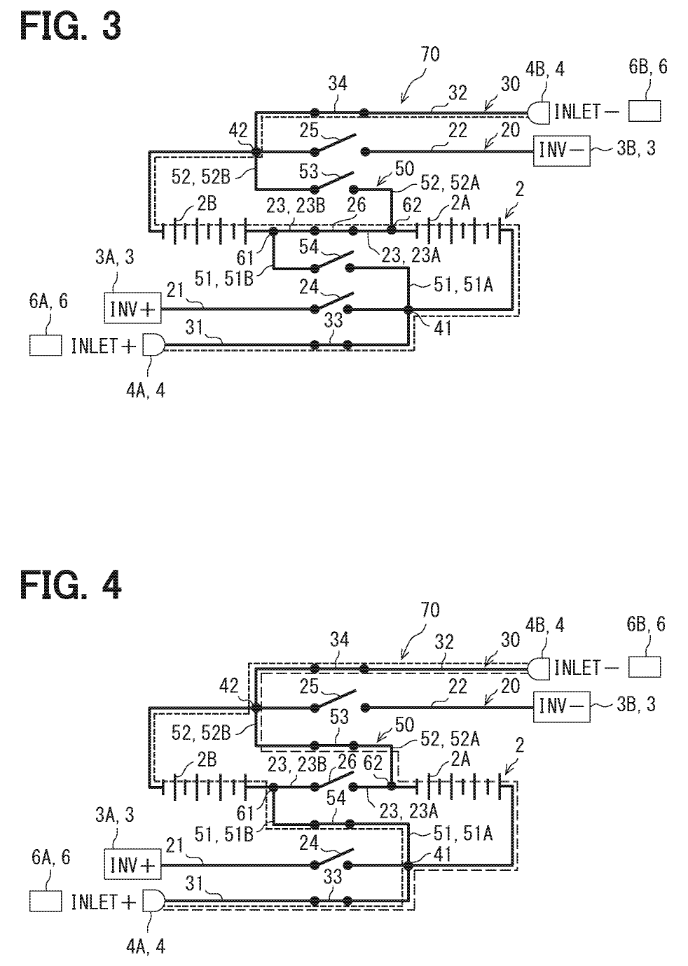

When charging the battery device 2 from the charging station 6, the processing unit outputs an OFF signal to the system main relays 24 and 25. When connected to a high-voltage rapid charger as the charging station 6, the processing unit outputs ON signals to the charging relays 33 and 34 and the series relay 26. In addition, the processing unit outputs OFF signals to the parallel relays 53 and 54, as well as to the system main relays 24 and 25. Accordingly, a current path through which an electric current flows, as indicated by a dashed line in FIG. 3, is formed. The current path includes a route passing through the energized relays 26, 33, and 34, the first battery 2A, the second battery 2B, the second positive wire 31, the second negative wire 32, and a section connecting the first connecting portion 41 and the second connecting portion 42 in the first wire 20.

Due to the above-mentioned electrical connection configuration, when connected to the high-voltage rapid charger, the first battery 2A and the second battery 2B are electrically connected in series. The potential difference between the second positive wire 31 and the second negative wire 32 is approximately 800 [V]. An external power supply of approximately 800 [V] is provided to the battery device 2 via a part of the first wire 20 and the second wire 30. The battery device 2 is charged by external power of approximately 800 [V].

### 400 [V] Charging

When connected to a low-voltage rapid charger as the charging stand 6, the processing unit outputs ON signals to the charging relays 33 and 34, as well as to the parallel relays 53 and 54. In addition, the processing unit outputs OFF signals to the series relay 26, as well as to the system main relays 24 and 25. According to this, two power supply paths through which electric current flows, as indicated by a dashed lines in FIG. 4, are formed.

One current path is a route that includes the energized relays 33, 34, and 53, the battery 2A, the second positive wire 31, the second negative wire 32, the third negative wire 52, and a section connecting the first connecting portion 41 of the first wire 20 and the fourth connecting portion 62. Through this path, external power of approximately 400 [V] is supplied to the first battery 2A. The first battery 2A is charged by external power of approximately 400 [V].

Another current path is a route that includes the energized relays 33, 34, and 54, the second battery 2B, the second positive wire 31, the second negative wire 32, the third positive wire 51, and a section of the first wire 20 connecting the second connecting portion 42 and the third connecting portion 61. Through this path, external power of approximately 400 [V] is supplied to the second battery 2B. The second battery 2B is charged by external power of approximately 400 [V].

It should be noted that the same function may be provided by stopping the output of the OFF signals, instead of outputting the ON signals, for each of the relays 24, 25, 26, 33, 34, 53, and 54. The same function may be provided by stopping the output of the ON signals, instead of outputting the OFF signals, for each of the relays 24, 25, 26, 33, 34, 53, and 54.

### Configuration of equipment module

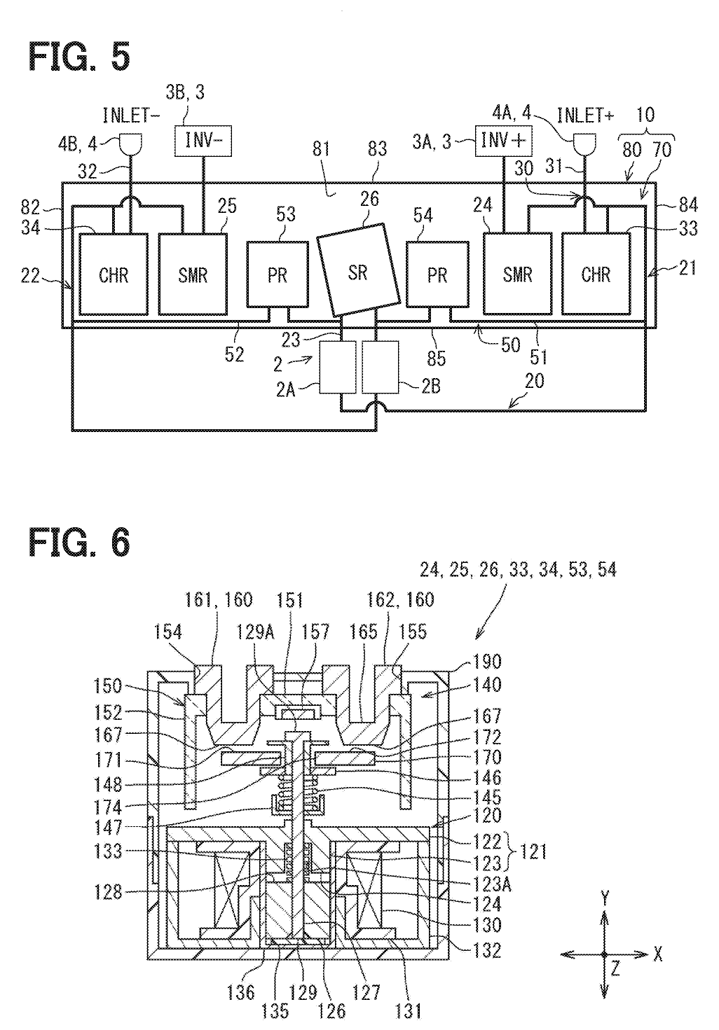

Next, a configuration of the high-voltage junction box 10 will be described with reference to FIG. 5. It should be noted that in each drawing, the components of the high-voltage junction box 10 are shown schematically. Hereinafter, three directions orthogonal to each other are referred to as an X-direction, a Y-direction, and a Z-direction. In the drawings, the description of "direction" may be omitted, and the description may be simply “X,” “Y” and “Z.” The high-voltage junction box 10 is provided on the vehicle body. As one example, the high-voltage junction box 10 is disposed below a floor of a vehicle compartment.

The high-voltage junction box 10 includes the power control circuit 70 and the mounting base 80. The mounting base 80 has a substantially rectangular parallelepiped shape. The mounting base 80 has a mounting surface 81 on which the power control circuit 70 is installed, and a placement surface on an opposite side. The seven relays 24, 25, 26, 33, 34, 53, and 54 are mounted on the mounting surface 81. A direction in which the seven relays 24, 25, 26, 33, 34, 53, and 54 and the mounting base 80 are aligned corresponds to the Z-direction. The seven relays 24, 25, 26, 33, 34, 53, and 54 are fixed to the mounting base 80 in the Z-direction. The mounting surface 81 and the placement surface are arranged apart from each other in the Z-direction. The placement surface is a surface that faces the floor of the vehicle compartment. By securing the placement surface to the floor of the vehicle compartment, the high-voltage junction box 10 is fixed to the vehicle. The mounting base 80 is mainly composed of an insulating resin as its primary material.

The mounting surface 81 extends in a planar direction along the X-direction and the Y-direction. The mounting surface 81 has a first end portion 82 and a third end portion 84 that are spaced apart in the X-direction. The mounting surface 81 has a second end portion 83 and a fourth end portion 85 that are spaced apart in the Y-direction. The first end portion 82 to the fourth end portion 85 are integrally connected in this order in a clockwise direction.

The series relay 26 is mounted at a center part in the X-direction on the mounting surface 81. The parallel relays 53 and 54 are mounted so as to sandwich the series relay 26 from both sides in the X-direction. The system main relays 24 and 25 are mounted on both sides of the parallel relays 53 and 54 in the X-direction, so as to sandwich the second changeover relays 53 and 54. The charging relays 33 and 34 are mounted on both sides of the second changeover relays 53 and 54 in the X-direction, so as to sandwich the parallel relays 53 and 54. It is not necessary for the series relay 26 to be mounted at the center part in the X-direction on the mounting surface 81. As long as the arrangement order is as described above, the position at which the series relay 26 is disposed on the mounting surface 81 is not limited to the center.

The arrangement of the seven relays 24, 25, 26, 33, 34, 53, and 54 will be described in more detail below. The series relay 26 is used as a reference. On the third end portion 84 side relative to the series relay 26, the plus parallel relay 54, the system plus main relay 24, and the charging plus relay 33 are arranged. On the first end portion terminal 82 side relative to the series relay 26, the minus parallel relay 53, the system minus main relay 25, and the charging minus relay 34 are arranged.

In addition, the battery device 2 is disposed adjacent to the fourth end portion 85 of the mounting base 80 in the Y-direction. The power conversion device 3 and the charging inlet 4 are arranged adjacent to the second end portion 83 of the mounting base 80 in the Y-direction. As described above, the battery device 2 and the seven relays 24, 25, 26, 33, 34, 53, and 54 are electrically connected by respective wire. The explanation of the connections of each wire has been provided above, and thus will be omitted here.

### Relay Configuration

FIG. 6 is a schematic diagram of relays 24, 25, 26, 33, 34, 53, and 54. The relays 24, 25, 26, 33, 34, 53, and 54 are composed of an electromagnetic actuator 120, a relay body 140, a relay housing 190, and the like. A reciprocating operation direction of the electromagnetic actuator 120 in the relays 24, 25, 26, 33, 34, 53, and 54 corresponds to an axial direction of a rod 129, which will be described later. A direction perpendicular to the axial direction may be referred to as an orthogonal direction. It should be noted that the axial direction of the rod 129 can also be expressed as an extending direction of the rod 129. The extending direction of the rod 129 may also be referred to as a longitudinal direction of the rod.

The electromagnetic actuator 120 is arranged alongside the relay body 140 in the axial direction. For convenience, a direction of the electromagnetic actuator 120 facing the relay body 140 is referred to as an upper direction, and a direction of the relay body 140 facing the electromagnetic actuator 120 is referred to as a lower direction. The electromagnetic actuator 120 is mechanically connected to the relay body 140. The electromagnetic actuator 120 supplies driving force for switching operation to the relay body 140.

The electromagnetic actuator 120 includes a stationary core 121, a movable core 126, a rod 129, an excitation coil 130, a coil housing 132, a return spring 133, a damper sheet 135, and a housing cylinder 136.

The stationary core 121 is formed from a magnetic material such as iron. The stationary core 121 has a base portion 122 and a cylinder portion 123. The base portion 122 is formed in a thin, plate-like shape in the axial direction. The stationary core 121 is arranged at a position facing the relay body 140, with a main surface of the base portion 122 aligned along a plane extending in the orthogonal direction. A through-hole that communicates with a spring accommodating hole 123A, which will be described later, is formed in the base portion 122.

The cylinder portion 123 is formed in a cylindrical shape. The cylinder portion 123 is integrally connected to the main surface of the base portion 122 on the electromagnetic actuator 120 side. The spring accommodating hole 123A and a first opposing surface 124 are provided in the cylinder portion 123. The spring accommodating hole 123A is a hole in which the return spring 133 is housed. The spring accommodating hole 123A is formed by an inner peripheral wall surface of the cylinder portion 123. The spring accommodating hole 123A communicates with the through-hole formed in the base portion 122. A diameter of the through-hole is smaller than a diameter of the spring accommodating hole 123A. The first opposing surface 124 is formed by a lower end surface of the cylinder portion 123, which faces downward.

The movable core 126 is formed in a cylindrical shape from a magnetic material such as iron. An outer diameter of the movable core 126 is substantially the same as, or slightly smaller than, an outer diameter of the cylinder portion 123. The movable core 126 is arranged below the cylinder portion 123 so as to be coaxial with the cylinder portion 123. The movable core 126 is provided with a rod holding hole 127 and a second opposing surface 128. The rod holding hole 127 is a hole for holding the rod 129. The rod holding hole 127 is formed by an inner peripheral wall surface of the movable core 126. The second opposing surface 128 is formed by an upper end surface of the movable core 126, which faces upward. A gap is interposed between the second opposing surface 128 and the first opposing surface 124. The stationary core 121 and the movable core 126 are opposed to each other with the gap interposed therebetween.

The rod 129 is formed in an elongated cylindrical shape from a non-magnetic metal material or the like. The rod 129 is inserted into a through-hole of the stationary core 121, which includes the spring accommodating hole 123A. A lower portion of the rod 129 is fitted inside the rod holding hole 127. The rod 129 reciprocates along the axial direction integrally with the movable core 126. The upper portion of the rod 129 passes through the spring accommodating hole 123A and protrudes upward from the base portion 122. The upper portion of the rod 129 is housed within the relay body 140.

The excitation coil 130 is formed by winding a thin wire material such as copper around the coil bobbin 131. The coil bobbin 131 is formed into a cylindrical or rectangular tube shape from a resin material. The excitation coil 130 is disposed so as to surround an outer peripheral of the cylinder portion 123 and the movable core 126. The excitation coil 130 is energized in accordance with a control signal output from a controller. When the excitation coil 130 is energized and brought into an excited state, the excitation coil 130 generates magnetic flux on the inner peripheral side along the axial direction.

The coil housing 132 is formed in a container shape with a closed bottom from a magnetic material such as stainless steel having ferromagnetic properties. The coil housing 132 is disposed below the base portion 122. An upper edge of the coil housing 132 is in contact with an outer edge of the base portion 122. The excitation coil 130 is housed inside the coil housing 132.

The return spring 133 is formed by helically winding a metal wire. The return spring 133 is disposed around the outer periphery of the rod 129. The return spring 133 is housed in the spring accommodating hole 123A in an axially compressed state between the cylinder portion 123 and the movable core 126. By its restoring force, the return spring 133 urges the movable core 126 in the axial direction away from the cylinder portion 123.

The damper sheet 135 is formed as a thin disc from a rubber material, resin material, or the like. The damper sheet 135 is disposed below the movable core 126. The damper sheet 135 contacts a lower end face of the movable core 126, which faces downward, and restricts the movement of the movable core 126 in a direction away from the cylinder portion 123.

The housing cylinder 136 is formed into a bottomed cylindrical shape from a metal material. The housing cylinder 136 accommodates the movable core 126 and the damper sheet 135. Am upper edge of a peripheral wall of the housing cylinder 136 is fitted onto an outer peripheral wall surface of the cylinder portion 123. An inner peripheral wall surface of the housing cylinder 136 slidably supports an outer peripheral wall surface of the movable core 126. The movable core 126 is capable of reciprocating displacement in the axial direction within the housing cylinder 136.

In the above electromagnetic actuator 120, a magnetic circuit is formed. The magnetic circuit is formed so as to surround the excitation coil 130 by the stationary core 121, the movable core 126, the coil housing 132, and the housing cylinder 136. When the excitation coil 130 is energized and magnetic flux is generated in the magnetic circuit, the movable core 126 is attracted to the stationary core 121 by magnetic force. The movable core 126 moves upward to reduce a gap between the stationary core 121 and the movable core 126. When the energization of the excitation coil 130 is stopped and the magnetic flux generated in the magnetic circuit disappears, the movable core 126 moves downward by the biasing force (urging force) of the return spring 133.

The relay body 140 includes a pressing spring 145, a pressing plate 146, a spring holder 147, a movable stopper 148, a sealed case 150, a fixed terminal 160, a movable terminal 170, and the like. The pressing spring 145, the pressing plate 146, the spring holder 147, the movable terminal 170, and the movable stopper 148 are mounted on the upper portion of the rod 129 protruding from the electromagnetic actuator 120.

The pressing spring 145 is formed by helically winding a metal wire. The pressing spring 145 is disposed on the outer peripheral side of the rod 129. The pressing spring 145 is disposed between the pressing plate 146 and the spring holder 147. The pressing spring 145 is compressed between the pressing plate 146 and the spring holder 147 by the upward displacement of the rod 129. The restoring force of the pressing spring 145 serves as an urging force that presses the movable terminal 170 against the fixed terminal 160.

The pressing plate 146 is formed in a plate shape from a metal material or the like. The pressing plate 146 is disposed between the pressing spring 145 and the movable terminal 170. The pressing plate 146 is capable of moving in an up-down direction with respect to the rod 129. The pressing plate 146 transmits the upward driving force of the electromagnetic actuator 120 and the upward biasing force of the pressing spring 145 to the movable terminal 170.

The spring holder 147 is formed in a flat, bottomed cylindrical shape from a metal material or the like. The spring holder 147 is fitted externally onto the rod 129 and is held by the rod 129. The spring holder 147 reciprocates along the axial direction integrally with the rod 129. The spring holder 147 accommodates a lower end of the pressing spring 145. The spring holder 147 compresses the pressing spring 145 in the axial direction as the rod 129 is displaced upward.

The movable stopper 148 is formed in a flanged cylindrical shape from a metal material or a hard resin material. The flange portion of the movable stopper 148 is positioned above the movable terminal 170. The movable stopper 148 reciprocates along the axial direction integrally with the rod 129. The movable stopper 148 comes into contact with the movable terminal 170 due to the displacement of the rod 129 in the downward (return) direction, and pushes the movable terminal 170 downward.

The sealed case 150 is formed from a ceramic material. The sealed case 150 has a container-like shape with a bottom. The sealed case 150 is disposed above the electromagnetic actuator 120 in an orientation with its opening facing downward. The sealed case 150 has an upper wall 151, four side walls 152, and a rod stopper 157.

The upper wall 151 is formed in a plate-like shape with a thickness in the axial direction. The upper wall 151 is formed with two terminal accommodating holes 154 and 155. The terminal accommodating holes 154 and 155 are through holes that penetrate the upper wall 151 in a direction of the plate thickness. The terminal accommodating holes 154 and 155 are formed at intervals in the orthogonal direction. The terminal accommodating holes 154 and 155 have circular openings.

The rod stopper 157 is formed in a plate shape from a metal material or a hard resin material. The rod stopper 157 is held by the relay housing 190 or the like. The rod stopper 157 is positioned above the upper end 129A of the rod 129 and faces the upper end 129A in the axial direction. The rod stopper 157 restricts the upward movement of the rod 129 by contacting the upper end 129A. The relay housing 190 is a case that houses the electromagnetic actuator 120 and the relay body 140. The relay housing 190 is formed in an overall box shape from a resin material or the like.

The fixed terminal 160 is formed from a metal material with excellent conductivity, such as copper. The fixed terminal 160 is electrically connected to a current path formed in the power control circuit 70. The fixed terminal 160 has a connection hole 165 and a fixed contact 167. The connection hole 165 is formed in a cylindrical shape. The connection hole 165 is used to secure a conductive member, such as a busbar that forms a current path, to the fixed terminal 160. The fixed contact 167 is formed on a bottom wall surface of the fixed terminal 160, which faces downward. The fixed contact 167 faces the movable terminal 170 in the axial direction. The fixed contact 167 comes into contact with the movable terminal 170 when the movable terminal 170 is displaced upward.

The fixed terminal 160 includes a first fixed terminal 161 and a second fixed terminal 162. The two fixed terminals 161 and 162 are respectively accommodated in the terminal accommodating holes 154 and 155, and are arranged side by side with a gap between them in the orthogonal direction. As described above, a busbar or the like that forms a current path is fixed to the fixed terminal 160. The busbar is held on each fixed terminal 161 and 162 by fastening members such as screws that are screwed into the connection holes 165.

The movable terminal 170 is formed in a plate shape having thickness in the axial direction, using a metal material with excellent conductivity such as copper. A rod insertion hole 174 is provided in the movable terminal 170. The rod insertion hole 174 is a through-hole that penetrates the movable terminal 170 in the plate thickness direction. The rod 129 is inserted into the rod insertion hole 174. The movable terminal 170 is attached to the rod 129 with its main surface aligned along a plane in the orthogonal direction. The movable terminal 170 is permitted to move in the up-down direction between the pressing plate 146 and the movable stopper 148.

The movable terminal 170 is pressed substantially evenly against both the first fixed terminal 161 and the second fixed terminal 162 by the urging force of the pressing spring 145. The movable terminal 170 has a first movable contact 171 and a second movable contact 172.

The first movable contact 171 is formed in a region of the upper surface of the movable terminal 170, which faces upward, that opposes the bottom wall surface of the first fixed terminal 161. The first movable contact 171 comes into contact with the fixed contact 167 of the first fixed terminal 161 when the first movable contact 171 is displaced upward. The first movable contact 171 assumes a closed state, that is, an ON state, with respect to the first fixed terminal 161. The first movable contact 171 separates from the fixed contact 167 of the first fixed terminal 161 when the movable terminal 170 is displaced downward. The first movable contact 171 assumes an open state, that is, an OFF state, with respect to the first fixed terminal 161.

Similarly, the second movable contact 172 is formed in a region of the upper surface of the movable terminal 170, which faces upward, that opposes the bottom wall surface of the second fixed terminal 162. As the movable terminal 170 is displaced upward, the second movable contact 172 comes into contact with the fixed contact 167 of the second fixed terminal 162 . The second movable contact 172 assumes a closed state, that is, an ON state, with respect to the second fixed terminal 162. The second movable contact 172 separates from the fixed contact 167 of the second fixed terminal 162 upon displacement of the second movable contact 172 in the downward direction. The second movable contact 172 assumes an open state, that is, an OFF state, with respect to the second fixed terminal 162.

### Series Relay and Parallel Relay

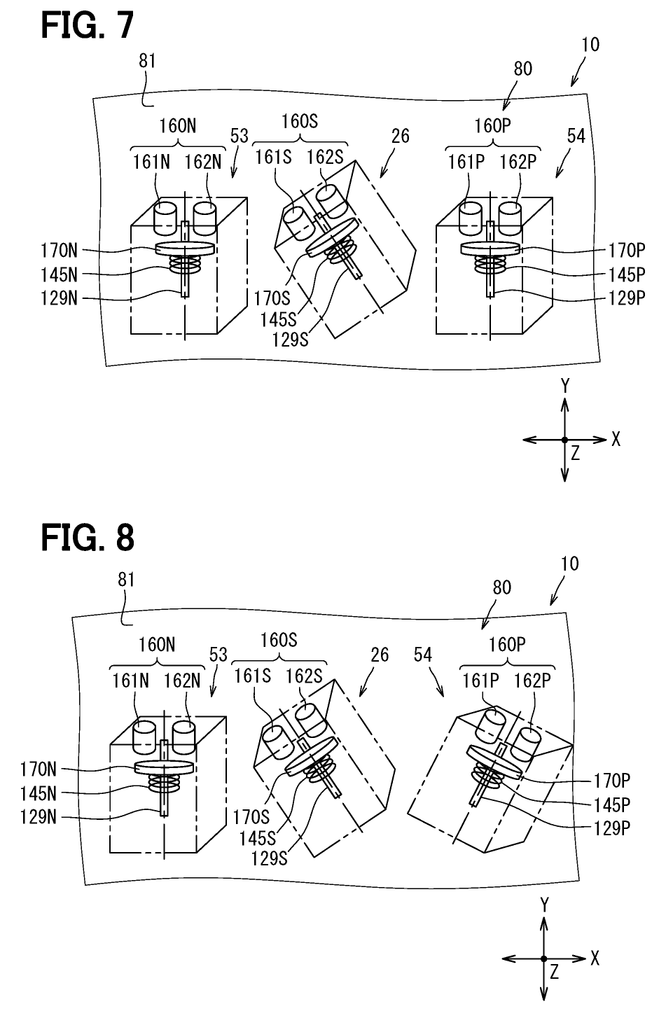

FIG. 7 is a schematic diagram showing portions extracted from the high-voltage junction box 10, the series relay 26, the parallel relays 53 and 54, and the mounting base 80. In FIG. 7, further, the rod 129, the pressing spring 145, the fixed terminal 160, and the movable terminal 170 are extracted from the series relay 26 and the parallel relays 53 and 54 and are illustrated. It should be noted that, in FIG. 7, these components are shown schematically. In the series relay 26 and the parallel relays 53 and 54, other components are not shown. Outlines of the series relay 26 and the parallel relays 53 and 54 are indicated by two-dot chain lines.

The series relay 26 includes a rod 129S, a pressing spring 145S, a fixed terminal 160S, and a movable terminal 170S. The negative parallel relay 53 includes a rod 129N, a pressing spring 145N, a fixed terminal 160N, and a movable terminal 170N. The positive parallel relay 54 includes a rod 129P, a pressing spring 145P, a fixed terminal 160P, and a movable terminal 170P. The components with the symbol "S" attached are elements of the series relay 26. The components with the symbol "N" attached are elements of the negative parallel relay 53. The components with the symbol "P" attached are elements of the positive parallel relay 54.

The fixed terminals 160S, 160N, and 160P may be referred to as connection fixed terminals. The rod 129P may be referred to as a first parallel rod. The rod 129N may be referred to as a second parallel rod. The rod 129S may be referred to as a series rod. The movable terminal 170S may be referred to as a series movable terminal. The fixed terminal 160S may be referred to as a series fixed terminal. The rods 129N and 129P may be referred to as parallel rods. The movable terminals 170N and 170P may be referred to as parallel movable terminals. The fixed terminals 160N and 160P may be referred to as parallel fixed terminals.

The fixed terminal 160S is electrically and mechanically connected to a busbar or the like that forms the third connecting piece 23. The third connecting piece 23 has a connecting piece 23A that is connected to the first battery 2A, and a connecting piece 23B that is connected to the second battery 2B. The first fixed terminal 161S of the fixed terminal 160S is connected to the first battery 2A via the connecting piece 23A. The second fixed terminal 162S of the fixed terminal 160S is connected to the second battery 2B via the connecting piece 23B.

The fixed terminal 160N is electrically and mechanically connected to a busbar or the like that forms the third negative wire 52. The third negative wire 52 has a connecting piece 52A that is connected to the first battery 2A, and a connecting piece 52B that is connected to the second battery 2B. The first fixed terminal 161N of the fixed terminal 160N is connected to the first battery 2A via the connecting piece 52A. The second fixed terminal 162N of the fixed terminal 160N is connected to the second battery 2B via the connecting piece 52B.

The fixed terminal 160P is electrically and mechanically connected to a busbar or the like that forms the third positive wire 51. The third positive wire 51 has a connecting piece 51A that is connected to the first battery 2A, and a connecting piece 51B that is connected to the second battery 2B. The first fixed terminal 161P of the fixed terminal 160P is connected to the first battery 2A via the connecting piece 51A. The second fixed terminal 162P of the fixed terminal 160P is connected to the second battery 2B via the connecting piece 51B.

In the first embodiment, the axial direction of the rod 129S of the series relay 26 is different from the axial directions of the parallel relays 53 and 54. As one example, the axial directions of the rod 129N and the rod 129P are the same. As one example, the axial directions of the rods 129N and 129P coincide with the Y-direction. The axial direction of the rod 129S does not coincide with the Y-direction. FIG. 7 shows a configuration in which, as an example, an oblique direction having both X-direction and Y-direction components is adopted as the axial direction of the rod 129S.

### Actions And Effects

The movable terminal 170 moves along the axial direction of the rod 129. The movable terminal 170 comes into contact with the fixed terminal 160 by moving upward. When the movable terminal 170 contacts the fixed terminal 160, the movable contacts 171 and 172 and the fixed contact 167 are brought into the closed state, that is, into the ON state. The movable terminal 170 separates from the fixed terminal 160 by moving downward. When the movable terminal 170 separates from the fixed terminal 160, the movable contacts 171 and 172 and the fixed contact 167 are brought into the open state, that is, into the OFF state. In the first embodiment, as described above, the axial direction of the rod 129S of the series relay 26 and the axial directions of the rods 129N and 129P of the parallel relays 53 and 54 are different.

For example, if vibration occurs along the axial direction of the rod 129S, the movable terminal 170S may be displaced in the up-down direction. The movable terminal 170S may unintentionally come into contact with the fixed terminal 160N due to vibration. In contrast, the movable terminals 170N and 170P are passed through the rods 129N and 129P, which have axial directions different from that of the rod 129S. Even if the movable terminals 170N and 170P attempt to be displaced in the axial direction of the rod 129S, their displacement can be reduced by the rods 129N and 129P. Accordingly, contact between the movable terminals 170N and 170P and the fixed terminals 160N and 160P can be reduced.

Similarly, if vibration occurs in the axial direction of the rods 129N and 129P, the movable terminals 170N and 170P may unintentionally come into contact with the fixed terminals 160N and 160P due to the vibration. In contrast, the movable terminal 170S is passed through the rod 129S, which has an axial direction different from that of the rods 129N and 129P. Even if the movable terminal 170S attempts to be displaced in the axial direction of the rods 129N and 129P, its displacement can be reduced by the rod 129S. Accordingly, contact between the movable terminal 170S and the fixed terminal 160S can be reduced.

In other words, the simultaneous ON state of the series relay 26 and the parallel relays 53 and 54 can be reduced. Regardless of whether the vehicle is in 800V driving mode, 800V charging mode, or 400V charging mode, the simultaneous ON state of the series relay 26 and the parallel relays 53 and 54 can be reduced. It is possible to suppress unintended changes to the current path of each mode caused by large vibrations. Unintended short-circuiting of the current path including the series relay 26 and the negative parallel relay 53 can be reduced. Unintended short-circuiting of the current path including the series relay 26 and the positive parallel relay 54 can be reduced.

### Second Embodiment

FIG. 8 is a schematic diagram showing, in a second embodiment, an excerpt of a high-voltage junction box 10, a series relay 26, parallel relays 53 and 54, and a portion of a mounting base 80. In the second embodiment, an axial direction of a rod 129S, an axial direction of a rod 129N, and an axial direction of a rod 129P are different from each other. As an example, the axial direction of the rod 129N coincides with the Y-direction. The axial direction of the rod 129S and the axial direction of the rod 129P do not coincide with the Y-direction. Furthermore, the axial direction of the rod 129S and the axial direction of the rod 129P are different from each other. As long as the axial direction of the rod 129S does not coincide with the Y-direction, it may be oriented in anY-direction (not Y-direction). As an example, the axial direction of the rod 129S and the axial direction of the rod 129P are oblique directions having both X-direction and Y-direction components. For example, the oblique directions of the axial direction of the rod 129S and the axial direction of the rod 129P may be individually defined so as to be symmetrical with respect to each other.

Accordingly, in addition to the effects of the first embodiment, it is possible to suppress the negative parallel relay 53 and the positive parallel relay 54 from being simultaneously turned on. When the negative parallel relay 53 and the positive parallel relay 54 are simultaneously turned on, a closed loop is formed in the current path that includes the negative parallel relay 53 and the positive parallel relay 54. If the voltage of the negative parallel relay 53 and the voltage of the positive parallel relay 54 are different, there is a possibility that a small current may flow through the current path including the negative parallel relay 53 and the positive parallel relay 54. In the second embodiment, simultaneous activation of the negative parallel relay 53 and the positive parallel relay 54 can be reduced. Therefore, when the voltage of the negative parallel relay 53 and the voltage of the positive parallel relay 54 are different, the flow of a small current through the electrical wiring including the negative parallel relay 53 and the positive parallel relay 54 can be reduced.

### Third Embodiment

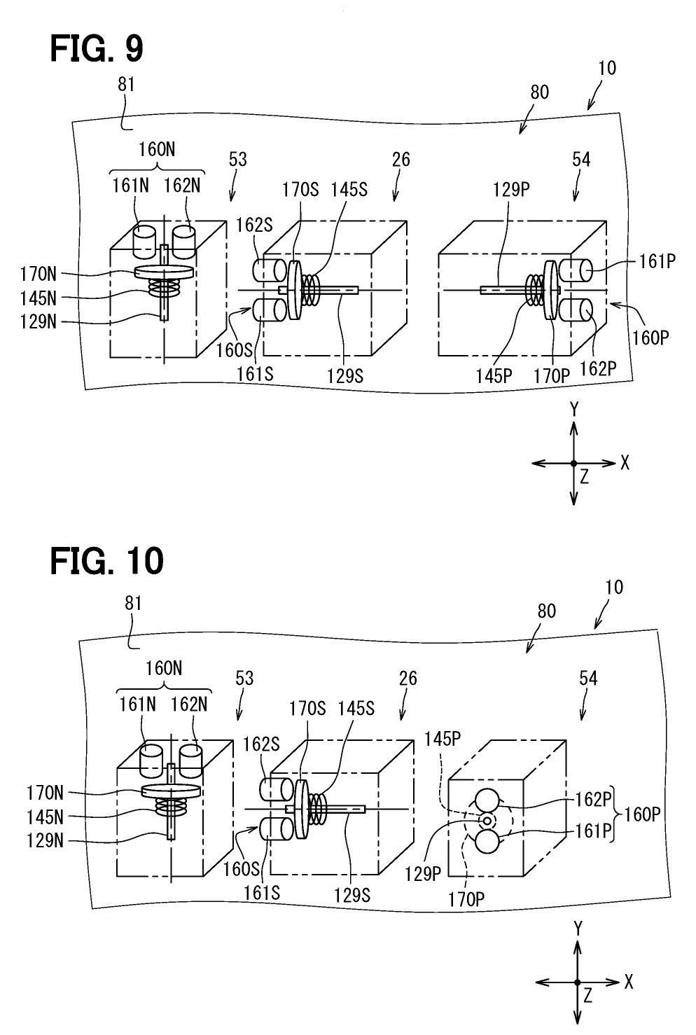

FIG. 9 is a schematic diagram showing, in a third embodiment, an excerpt of a high-voltage junction box 10, a series relay 26, parallel relays 53 and 54, and a portion of a mounting base 80. In the third embodiment, axial directions of two out of the three rods 129S, 129N, and 129P are the same. A direction in which one of the movable terminals 170 of the rod 129 with the same axial direction approaches the fixed terminal 160 is different from a direction in which the other movable terminal 170 of the rod 129 with the same axial direction approaches the fixed terminal 160. A direction in which one of the movable terminals 170 approaches the fixed terminal 160 is opposite to a direction in which the other movable terminal 170 approaches the fixed terminal 160.

As an example of the third embodiment, an axial direction of the rod 129S and an axial direction of the rod 129P are the same. In the same axial direction, the direction in which the movable terminal 170S approaches the fixed terminal 160S is different from the direction in which the movable terminal 170P approaches the fixed terminal 160P. The direction in which the movable terminal 170S approaches the fixed terminal 160S is opposite to the direction in which the movable terminal 170P approaches the fixed terminal 160P. Moreover, the axial directions of the rods 129S and 129P are different from the axial direction of the rod 129N.

More specifically, in an example of the third embodiment shown in FIG. 9, the axial direction of the rod 129S and the axial direction of the rod 129P are aligned in the X-direction. The axial direction of the rod 129N is different from the axial directions of the rod 129S and rod 129P. The axial direction of the rod 129N is aligned with the Y-direction. According to this, when vibration occurs in the X-direction in such a way that the movable terminal 170S approaches the fixed terminal 160S, the following is more likely to occur. The movable terminal 170S is more likely to come into contact with the fixed terminal 160S, while the movable terminal 170P is more likely to move away from the fixed terminal 160S. Even if vibration in a specific direction along the X-direction is applied to the high-voltage junction box 10, simultaneous activation of the relays 26 and 54, which have different orientations on the same axis, can be reduced.

In general, vehicles are susceptible to significant impacts from one direction, such as frontal or rear collisions in a front-rear direction, side collisions in a left-right direction, or large impacts from events like running over obstacles in an up-down direction. By applying the high-voltage junction box 10 of the third embodiment to a vehicle, it is possible to effectively suppress the simultaneous activation of two relays 26, 54, and 55, which are arranged in the same axial direction but with different orientations, in response to an impact from one direction.

As a preferred example, in the third embodiment, the axial direction of the rod 129S coincides with any one of the front-rear direction, the left-right direction, or the up-down direction of the vehicle. In that case, the movable terminal 170S can be displaced only in response to an impact along this direction. The axial directions of the rods 129N and 129P each coincide with one of the front-rear direction, the left-right direction, or the up-down direction of the vehicle, which is different from the axial direction of the rod 129S. Each movable terminal 170N and 170P can be displaced only in response to an impact along this direction. Accordingly, the displacement of the movable terminals 170S, 170N, and 170P can be effectively reduced.

As described above, in the third embodiment, it is expected that when an impact is applied from one direction along the axial direction, the two coaxial relays will not be simultaneously turned on. However, the pressing spring 145 possesses elasticity. Therefore, among the two relays, the movable terminal 170 of the relay that is expected to be in the off state may unintentionally turn on due to the biasing force of the pressing spring 145. In such a case, there is a possibility that both relays may unintentionally be turned on simultaneously.

It should be noted that, as another example, the axial direction of the rod 129S and the axial direction of the rod 129N may be the same. In that case, in the same axial direction, the direction in which the movable terminal 170S approaches the fixed terminal 160S differs from the direction in which the movable terminal 170N approaches the fixed terminal 160N. The direction in which the movable terminal 170S approaches the fixed terminal 160S is opposite to the direction in which the movable terminal 170N approaches the fixed terminal 160N.

Furthermore, as another example, the axial direction of the rod 129N and the axial direction of the rod 129P may also be the same. In that case, in the same axial direction, the direction in which the movable terminal 170N approaches the fixed terminal 160N differs from the direction in which the movable terminal 170P approaches the fixed terminal 160P. The direction in which the movable terminal 170N approaches the fixed terminal 160N is opposite to the direction in which the movable terminal 170P approaches the fixed terminal 160P. In these cases as well, the same effects as described above can be achieved.

### Fourth Embodiment

FIG. 10 is a schematic diagram showing, in a fourth embodiment, an excerpt of a high-voltage junction box 10, a series relay 26, parallel relays 53 and 54, and a portion of a mounting base 80. In a fourth embodiment, the axial direction of the rod 129S, the axial direction of the rod 129N, and the axial direction of the rod 129P are mutually orthogonal. As an example of the fourth embodiment, the axial direction of the rod 129S coincides with the Y-direction. The axial direction of the rod 129S coincides with the X-direction. The axial direction of the rod 129P coincides with the Z-direction.

When the high-voltage junction box 10 of the fourth embodiment is applied to a vehicle, the axial directions of the rods 129S, 129N, and 129P respectively correspond to the front-rear direction, the left-right direction, and the up-down direction of the vehicle. This prevents the series relay 26, the negative parallel relay 53, and the positive parallel relay 54 from being turned on simultaneously, regardless of the direction of vibration. Furthermore, even if an impact is applied along any axial direction, the simultaneous ON state of two relays can be reduced.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. An equipment module for switching between a series connection and a parallel connection of a first battery and a second battery, the equipment module comprising:
a series relay configured to connect the first battery and the second battery in series; and
a parallel relay configured to connect the first battery and the second battery in parallel, wherein
the series relay includes:
a series fixed terminal electrically connected to a current path;
a series movable terminal configured to come into contact with and separate from the series fixed terminal; and
a series rod extending through the series movable terminal so as to guide movement of the series movable terminal,
the parallel relay includes:
a parallel fixed terminal electrically connected to a current path that is different from the current path to which the series fixed terminal is connected;
a parallel movable terminal configured to come into contact with and separate from the parallel fixed terminal; and
a parallel rod extending through the parallel movable terminal so as to guide movement of the parallel movable terminal, and
an extending direction of the series rod and an extending direction of the parallel rod are different from each other.

2. The equipment module according to claim 1, wherein
the parallel relay includes:
a first parallel relay provided in a wire that connects a positive electrode of the first battery and a positive electrode of the second battery; and
a second parallel relay provided in a wire that connects a negative electrode of the first battery and a negative electrode of the second battery,
the first parallel relay includes a first parallel rod that is the parallel rod, and
the second parallel relay includes a second parallel rod that is the parallel rod.

3. The equipment module according to claim 2, wherein
the extending direction of the series rod, an extending direction of the first parallel rod, and an extending direction of the second parallel rod are different from one another.

4. The equipment module according to claim 2, wherein
a first direction is a direction in which the series movable terminal approaches the series fixed terminal,
a second direction is a direction in which the parallel movable terminal of the first parallel relay approaches the parallel fixed terminal of the first parallel relay,
a third direction is a direction in which the parallel movable terminal of the second parallel relay approaches the parallel fixed terminal of the second parallel relay, and
the first direction, the second direction and the third direction are different from one another.

5. The equipment module according to claim 2, wherein
the extending direction of the series rod, the extending direction of the first parallel rod, and the extending direction of the second parallel rod are orthogonal to one another in three mutually different directions.

6. The equipment module according to claim 5, wherein
the equipment module is mounted on a vehicle, and
the three mutually different directions correspond to a front-rear direction of the vehicle, a left-right direction of the vehicle, and an up-down direction of the vehicle.

7. The equipment module according to claim 1, wherein
the parallel fixed terminal is electrically connected to wires to which electric power for charging the first battery or the second battery is supplied.
